(19) United States
(12) Patent Application Publication
(10) Pub. No.: US 2009/0094056 A1
(43) Pub. Date: Apr. 9, 2009

(54) Systems And Methods For Projecting Sample Store Activities That Are Restricted In Non-Sample Stores

(76) Inventors: Heather Aeder, Flourtown, PA (US); Mary Ann Cornwall, Langhorne, PA (US); Sara Stroman, Conshohocken, PA (US); Chris Boardman, Collegeville, PA (US)

Correspondence Address: BAKER BOTTS L.L.P., 30 ROCKEFELLER PLAZA, 44TH FLOOR, NEW YORK, NY, 10112-4498, US

(21) Appl. No.: 12/147,172

(22) Filed: Jun. 26, 2008

Related U.S. Application Data
(60) Provisional application No. 60/947,202, filed on Jun. 29, 2007.

(51) Int. Cl. G06Q 50/00

(52) U.S. Cl. 705/2; 705/7

(57) ABSTRACT

Systems and methods are provided for estimating non-sampled store activities by applying projection factors to sampled store activities taking into account restrictions on non-sampled store activities. The systems and methods adjust data projection factors for managed healthcare plans that have restrictions in non-sampled stores to prevent unrestricted activity under these plans at sample stores from being projected into non-sample stores where such projected activity would be restricted. Conventional sampled-to-non-sampled store projection factors leading to restricted plan activities are reallocated to non-restricted plan activities in the non-sample store based on the historical ratio of such activities observed in sample stores.

### CROSS REFERENCE TO RELATED APPLICATIONS

This application claims priority to U.S. Provisional Application Serial No. 60/947,202, filed Jun. 29, 2007, which is incorporated by reference in its entirety herein.

### TECHNICAL FIELD

The presently described subject matter relates generally to systems and methods for predicting market conditions. The described subject matter in particular relates to devices and techniques for predicting market demand for pharmaceutical and other healthcare products.

### BACKGROUND

Assignee IMS Health (“IMS”) provides useful market data analysis and information solutions for pharmaceutical and healthcare industries. For example, IMS provides a pharmaceutical companies improve the effectiveness of their field sales forces. Xponent now offers expanded tracking capabilities for the long-term care channel and specialty retail products. Product sales or activity at pharmaceutical stores or outlets is projected from limited sampled store data.

Some of the projection methodologies used in Xponent are described in patents and patent applications owned by IMS (e.g., Felthauser et al. U.S. Pat. No. 5,420,786 and U.S. Pat. No. 5,781,893, etc.). Techniques for store sizing (i.e., estimating sales volume or activity) are based on statistical sampling of retail outlet sales assuming, for example, geographical uniformity and homogeneity in the universe of outlets in the marketplace. Actual sales data from sampled outlets in the universe of outlets is geo-spatially projected or extrapolated to estimate sales at non-sampled outlets. In particular, U.S. Pat. Nos. 5,420,786 and 5,781,893, which are incorporated by reference in their entireties herein, teach estimating sales activity of a product at an unsampled retail sales outlet using sampled outlets and the distances between the sampled and unsampled outlets. Suitable adjustments to the projection factors can made for specialty products for which the assumptions of geographical uniformity and homogeneity do not apply. (See e.g., C. Boardman et al. U.S. Pat. No. 7,174,304 B1, which is incorporated by reference in its entirety herein). Further, adjustments can be made for gaps or delays in sample store reporting (“missing suppliers”) using, for example, solutions described in C. Boardman et al. U.S. Patent application Publication No. 20060206365 A1, which is incorporated by reference in its entirety herein.

IMS also provides an enhanced information solution PlanTrak™, which is designed to address the managed care issues facing pharmaceutical companies. IMS PlanTrak™ provides insights into the influence of managed care plans, allowing users to pinpoint key managed care organizations and track the effects of formulary changes and compliance across plans. Compiling data from thousands of retail pharmacies at both the payer and plan levels, PlanTrak makes it easier for users to design the best approaches, validate managed care rebates, and target plans with the best potential. Like Xponent, PlanTrak applies suitable statistical projection factors to data from sampled stores and outlets to obtain estimates of activity at non-sampled stores or outlets.

In practice, incoming market data from reporting outlets (e.g., for a current week forecast) is combined with previously calculated projection factors to create new projection factors for the current week. The new projection factors are used to project the product sales for the sample stores. Based on both the reported and projected sales data for the sample stores, the product level distribution factors are computed. These product level distribution factors are used to project the prescription sales for all non-sample outlets.

A drawback of existing projection methodologies is that they do not distinguish or account for managed care plan restrictions on store or outlet type. For example, managed care organizations may restrict their members to have prescriptions filled only at certain pharmacies. The conventional projection methodologies do not consider the effect of plan restrictions on use of non-sample outlets by their members. Using the conventional projection methodologies, it is possible to inappropriately project “non-restricted” activity (e.g., prescriptions) in sample stores or outlets into non-sample stores or outlets in which such activity would be restricted or not allowed under the managed care plans.

Consideration is now being given to improving devices and techniques to properly account for store-by-store plan restrictions in the information solutions for pharmaceutical and healthcare industries.

### SUMMARY

Systems and methods are provided for market data analysis and market activity estimation in the pharmaceutical and healthcare industries. The systems and methods account for store-by-store restrictions (e.g., store -by-store activity restrictions under managed care plans). The systems and methods are collectively referred to hereinafter as “Restricted Plan solutions.”

In some embodiments, the Restricted Plan solutions project market activity data from sample stores or outlets to estimate activity at non-sample stores taking into account managed care plan restrictions. The Restricted Plan solutions adjust data projection factors for managed care plans that have restrictions in non-sample outlets, to prevent unrestricted activity under these plans at sample stores from being projected into non-sample stores/outlets where such activity would be restricted. The projection methodology does not cause any variation in estimated total prescriptions (“TRx”) at the product or prescriber levels. Projection factors, which under conventional methodology would be associated with restricted plan activities in non-sample outlets, are re-assigned or reallocated to non-restricted plan activities in non-sample outlets. The reassignment or reallocation of projected restricted plan activities to non-restricted activities may be based on the historical ratio of such activities observed in sample prescriptions (Rxs).

The Restricted Plan solutions may provide users with accurate representations of managed care organization prescription activities, enabling better decision making.

Some embodiments include a procedure for projecting sample store activities that are restricted in non-sample stores including identifying restricted activities data within a projection, the restricted activities data indicating activities disallowed at nonsample stores; removing the restricted activities data from the projection; generating replacement activities data for the nonsample stores; and reassigning the replacement activities data to non-restricted plans based at least in part on factors applied to nonrestricted activities at nonsample stores. In some embodiments, the activities may include scripts purchases. In others, the estimated total activities may remain constant. The procedure may further include reassigning the replacement activities data based at least in part on historical ratios of sampled, restricted activities to sampled, non-restricted activities.

Some embodiments include a procedure for projecting sample store activities that are restricted in non-sample stores including determining restricted outlet-plan combinations applicable in a market region; generating exclusion lists of nonsample stores; generating restricted plan allocation data; generating restricted plan adjustments (RPA) factors data; selecting, from a current week sample TRxs data file, a first group including scripts associated with a restricted plan and a second group including scripts not associated with a restricted plan; appending RPA factors to one or more scripts in the first group; and adjusting missing supplier records. Some embodiments further include generating reverse roster data identifying which outlets a restricted plan is not allowed to fill prescriptions for. Others include generating the roster data by combining the current month next generation prescription services universe, current month plan rosters for restricted plans, and coverage area. Some embodiments include summing, at the outlet-product-plan level, non-missing supplier weights to create RPA factors

Some embodiments include a procedure for projecting sample store activities that are restricted in non-sample stores including determining restricted outlet-plan combinations; exploding an exclusion/inclusion parameter files; creating a restricted plan allocation file; appending allocations to weight files; creating factor files from the weight files; transforming factors; splitting sample file; applying factors to rxs; splitting missing supplier weights; and appending missing supplier weights to sample rxs.

Some embodiments include an article of manufacture including a computer readable medium having computer executable instructions embodied therein, the computer instructions for projecting sample store activities that are restricted in non-sample stores, the computer executable instructions causing a computer system to perform the procedure including identifying restricted activities data within a projection, the restricted activities data indicating activities disallowed at nonsample stores; removing the restricted activities data from the projection; generating replacement activities data for the nonsample stores; and reassigning the replacement activities data to non-restricted plans based at least in part on factors applied to nonrestricted activities at nonsample stores. In some embodiments, the activities include scripts purchases. In others, the estimated total activities remains constant. Some embodiments include reassigning the replacement activities data based at least in part on historical ratios of sampled, restricted activities to sampled, non-restricted activities.

### BRIEF DESCRIPTION OF THE DRAWINGS AND APPENDICES

Further features of the described subject matter, its nature, and various advantages will be more apparent from the following detailed description of the preferred embodiments and the accompanying drawings, wherein like reference characters represent like elements throughout, and in which:

FIG. 1 is a block diagram of an exemplary prescription activity estimation process based on the Restricted Plan projection methodology, in accordance with the principles of the presently described subject matter;

FIG. 2 illustrates an exemplary input original activity reporting table and a resulting output Restricted Plan Adjustments (RPA) table created by the prescription activity estimation process of FIG. 1, in accordance with the principles of the presently described subject matter;

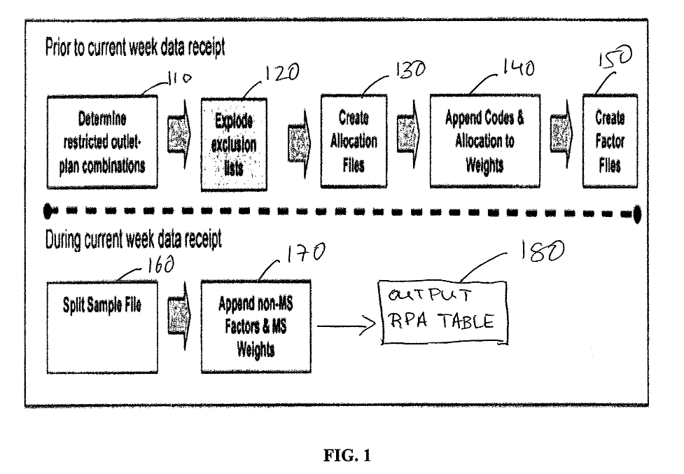

APPENDIX A is a list of exemplary input and output data files of the prescription activity estimation process of FIG. 1, in accordance with the principles of the presently described subject matter;

APPENDIX B provides Technical Specifications for an exemplary implementation of the prescription activity estimation process of FIG. 1, in accordance with the principles of the presently described subject matter;

APPENDIX C provides functional and system specifications for an exemplary product implementation of the prescription activity estimation process of FIG. 1 in existing projection methodology systems (e.g., Missing Data Supplier projection methodology system, Appendix D), in accordance with the principles of the presently described subject matter; and

APPENDIX D provides functional and system specifications for an exemplary Missing Data Supplier projection methodology product, which may be used as a base for implementation of the prescription activity estimation process of FIG. 1, in accordance with the principles of the presently described subject matter. The Missing Data Supplier projection methodology product may be based on solutions that are described, for example, in C. Boardman et al. U.S. Patent application Publication No. 20060206365 A1.

### DETAILED DESCRIPTION

Solutions (hereinafter Restricted Plan solutions) are provided for accurately estimating market activity based on sample store activity data.

The restricted plan solutions may be implemented in conjunction with other solutions for estimating pharmaceutical sales activity including, for example, Xponent and Plan Track, and solutions described in C. Boardman et al. U.S. Patent publication No. 20060190288. APPENDIX D shows functional and system specifications for an exemplary Missing Data Supplier projection methodology product, which may be used as a base for implementation of the Restricted Plan solutions. APPENDIX C provides functional and system specifications for an exemplary product implementation of Restricted Plan solutions in the Missing Data Supplier projection methodology system of Appendix D). The accompanying appendices are provided for illustrative purposes only, and unless explicitly specified, are not intended to limit the scope of the described subject matter.

The Restricted Plan solutions properly account for store-by-store activity restrictions (e.g., store -by-store activity restrictions under managed health care plans) in projecting store activity from one store to another. A managed health care plan is considered restricted if the patients who use that plan are limited to purchasing scripts from specific pharmacies included on that plan's roster. The inventive Restricted Plan solutions use a projection methodology that limits or restricts the non-sample outlets into which sample outlet activities are projected. The Restricted Plan projection methodology removes plan activities, which would be restricted or not allowed in the non-sample outlets, from the projections. The removed activities are proportionately reassigned or reallocated to non-restricted plan activities in the non-sample outlets. “Cloned” records are created based on the disallowed original sample script. Factors made from weights with a non-roster non-sample outlet that are applied to the sample scripts with a restricted plan are reallocated to non-restricted plans.

In this manner, the Restricted Plan projection methodology does not cause any variation in the estimated total scripts or prescriptions (“TRx”) at the product or prescriber levels.

In exemplary implementations, the Restricted Plan projection methodology adjusts down the projection factor on sample scripts with the restricted plan. The amount of downward adjustment of projection factor is then reallocated to ‘cloned’ scripts associated with a different plan (which is not restricted in the non-sample store). A cloned script is a projected script with identical attributes to a sample script with the restricted plan (it would not be counted as raw). The allocation percentages may be determined on a historical basis. After reallocation, the product level (i.e. CMF7/USC descriptor-level) and doctor-level projections will add up to the same number of scripts. However, the plan-level projections will change because of the reallocation of the restricted plan scripts.

FIG. 1 shows an exemplary prescription activity estimation process 100 based on the Restricted Plan projection methodology. Process 100 may be run at suitable times (e.g., weekly) to obtain estimates of prescription activities in a market region based on sample store data received during a period. The input files for the prescription activity estimation process 100 may include Store universe files (e.g., Next Generation Prescription Services (NGPS) store universe files), Roster files, plan coverage files, prior weeks of sample TRxs, prior weeks of weights, current week sample TRxs, Parameter files, plan inclusion lists, and plan exclusion lists. APPENDIX A is a list of exemplary input and output data files of the prescription activity estimation process 100.

Prior to the current week sample store data receipt, at step 110, a determination is made of all restricted outlet-plan combinations applicable in the market region. A reverse roster identifying which outlets a restricted plan is not allowed to fill prescriptions is created. The reverse roster may be limited to restricted plans and to outlets within the plans' coverage area. Such a reverse roster may be created by combining the current month NGPS Universe, current month plan rosters for restricted plans, and coverage area.

At step 120, exclusion lists of nonsample stores for specific plans are developed. At step 130, restricted plan allocation files are created. The allocation file identifies which non-restricted plans are able receive the restricted plan's taken away TRxs, and what proportion of the total TRxs each non-restricted plan should receive. In practice, the allocation file can be created, for example, by combining X weeks (e.g., X=4) of weights and sample scripts to obtain a dataset at the sample outlet-non sample outlet- product-plan level file. The restricted plan data comes from the sample TRxs. A “Weighted Rx” value may be calculated based on the number of sample scripts and value of the weight calculated as: Weighted TRxs=(Weight*Sum of Rxs). The combination is limited to records corresponding to those non-sample outlets that appear in the reverse roster. Additionally, records are removed where the restricted plan is a New plan. Further, records are also removed when the New Plan is on the plan exclusion list. Conversely, if a restricted plan is on the plan inclusion list, then it is allowed to be reallocated to new plans with model types identified on the plan inclusion list. This limitation is expected to affect a few of the common restricted plans. The allocation percentages may be calculated, for example, as: Allocation %=Weighted Rxs/Total Weighted Rxs, where Total Weighted Rxs is the Weighted Rxs rolled up to the Sample Outlet-NS Outlet-Product level. Records may be removed where the Allocation % is less than a cutoff X % (e.g., 0.5%). The Allocation % may be then recalculated after the below cutoff records are removed to maintain a 100% allocation at the Outlet-NS Outlet-Product level.

Xponent PlanTrak has outlet-plan level factors. In contrast, process 100 may create outlet-product-plan level factors for those products and outlets that need them. Others use normal outlet-product level factors. To obtain these factors, first at step 140, the Codes and Allocation file is combined with the store weights file (e.g., distance weights). The allocation file has 100% allocation for each weight record. If the non-sample outlet in the weight file has a restricted plan, but no allocation record is found then the restricted plan is identified as New Plan=Plan X. Plan and the allocation % may be set to =100%. Plan X may be a parameter e.g., =‘8888880001’. When combined, the allocation file distributes the original weight across the allowable non-restricted plans.

Next at step 150, a restricted plan adjustments (RPA) factors file is created. Non-missing supplier weights are summed at the outlet-product-plan level to create RPA factors. Some of the plans will be blank—this factor will be for the factor that comes from non-sample outlets with no restrictions. The RPA factors file is different from the existing, unmodified, factor file, which is still used in a separate stream.

During or after the current week sample store data receipt, at step 160, the current week sample TRxs data file is split and RPA factors are appended. The current week sample TRxs data file is split in two groups having a restricted plan and not having a restricted plan, respectively (e.g., Group 1 and Group 2). RPA adjusted factors are appended to the Group 1 scripts at the sample outlet plan level. Conversely, normal non-adjusted factors are appended to Group 2 the Group 1 scripts at the sample outlet plan level. It is noted that the Group 1 scripts also go through normal processing, but the normal processing records are backed out in the RPA table (step 180).

At step 170 missing supplier records are adjusted. Missing supplier (MS) weights and non -missing supplier factors are appended to the split files and output to an RPA table (step 180). To adjust missing supplier records, missing supplier weights are split in two categories Group A and Group B, which correspond to non sample outlets which have and do not have a restricted plan, respectively. No adjustments are made to missing supplier records for Group A records. If a Group B weight is used to create a “borrowed” or cloned script, which is not dropped in the cutoff/rounding procedure, the restricted plan on the record is changed to reflect the new non-restricted plan. If the plan is so changed, the PBM BIN ID is set to null to prevent the particular record from having its prescriber entry changed in any down stream missing supplier adjustment processes. The results of step 170 are output to an RPA table at step 180.

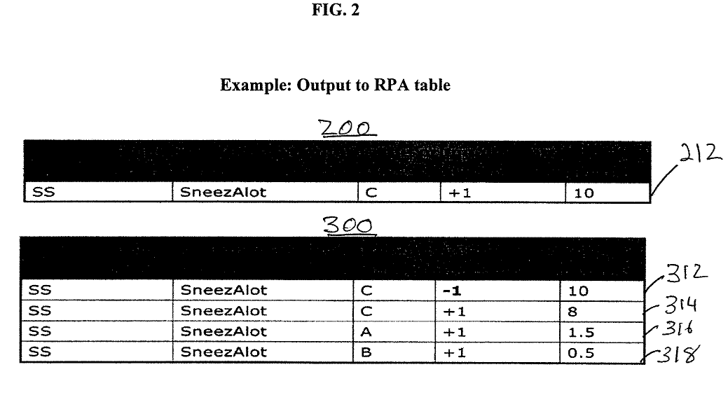

FIG. 2 shows an exemplary output RPA table 300 and an exemplary original reporting Table 200. As shown, Table 200 contains an original prescription record 212 for product “SneezeAlot” filled at sample outlet “SS” under Plan C. However, plan C may be restricted in non-sample outlet NN, which is associated with sample outlet SS, After process 100, RPA table 200 includes a negative “back out” record 312 to remove the restricted script 212 with the original unadjusted factor. Further, RPA table 300 includes a positive “feed back” record 314 that maintains the original characteristics, including the restricted plan C. This record 314 does not need to have an adjusted plan as it is used for or associated with non-sample outlets NN that not have restrictions under Plan C. RPA table 300 also includes a positive “feed back” records 316 and 318 that are used for or associated with non-sample outlets NN that do have restrictions under Plan C. These records for have adjusted plans (e.g., Plan A and Plan B, respectively) indicating the reallocation of the projection of restricted script 212 to non restricting plans A and B.

Appendix B lists Technical Specifications for an exemplary implementation of prescription activity estimation process 100. In the exemplary implementation, Restricted Plans and other special cases are reallocated in the retail channel. All reference files and input files use retail data. Rosters and geographies (coverage areas) are available for all restricted plans in a mainframe file. Weight files are created and capped. Certain plans are excluded from reallocation. These are the same across all outlets and are made available in a parameter file (Parameter File). Restricted plans with certain model types are allowed to be reallocated to specific model types. These are the same across all outlets and are be available in a parameter file (Parameter File). All appropriate cross-references will be applied based on current week files.

In accordance with the presently described subject matter, software (i.e., instructions) for implementing the aforementioned Restricted Plan solutions/devices and techniques (algorithms) can be provided on computer-readable media. It will be appreciated that each of the procedures (described above in accordance with this described subject matter), and any combination thereof, can be implemented by computer program instructions. These computer program instructions can be loaded onto a computer or other programmable apparatus to produce a machine such that the instructions, which execute on the computer or other programmable apparatus, create means for implementing the functions of the aforementioned systems and methods. These computer program instructions can also be stored in a computer-readable memory that can direct a computer or other programmable apparatus to function in a particular manner such that the instructions stored in the computer-readable memory produce an article of manufacture including instruction means, which implement the functions of the aforementioned systems and methods. The computer program instructions can also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of the aforementioned systems and methods. It will also be understood that the computer-readable media on which instructions for implementing the aforementioned systems and methods are be provided include, without limitation, firmware, microcontrollers, microprocessors, integrated circuits, ASICS, and other available media.

In some embodiments, one or more computer components, working together with said software or instructions, may be provided to implement the described subject matter. A first example may include one or more of an identifying component for identifying restricted activities data within a projection, the restricted activities data indicating activities disallowed at nonsample stores, a removal component for removing the restricted activities data from the projection, a generation component for generating replacement activities data for the nonsample stores, and a reassignment component for reassigning the replacement activities data to non-restricted plans based at least in part on factors applied to nonrestricted activities at nonsample stores.

A second example may include one or more of a combination determination component for determining restricted outlet-plan combinations applicable in a market region, an exclusion list component for generating exclusion lists of nonsample stores, a restricted allocation data component for generating restricted plan allocation data, a plan adjustments component for generating restricted plan adjustments (RPA) factors data, a selection component for selecting, from a current week sample TRxs data file, a first group including scripts associated with a restricted plan and a second group including scripts not associated with a restricted plan, an appending component for appending RPA factors to one or more scripts in the first group, an adjustment component for adjusting missing supplier records, a reverse roster data component for generating reverse roster data identifying which outlets a restricted plan is not allowed to fill prescriptions for, a combination component for generating the roster data by combining the current month next generation prescription services universe, current month plan rosters for restricted plans, and coverage area, a summing component for summing, at the outlet-product-plan level, non-missing supplier weights to create RPA factors

A third example may include one or more of a combination determination component for determining restricted outlet-plan combinations, an explosion component for exploding an exclusion/inclusion parameter files, a plan application component for creating a restricted plan allocation file, a weight files component for appending allocations to weight files, a factor files component for creating factor files from the weight files, a factor transformation component for transforming factors, a splitting component for splitting sample file, a factor application component for applying factors to rxs, a missing weights splitting component for splitting missing supplier weights, and a supplier weights application component for appending missing supplier weights to sample rxs.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within the spirit and scope thereof.

What is claimed is:

1. A method for projecting sample store activities that are restricted in non-sample stores, comprising:
identifying restricted activities data within a projection, the restricted activities data indicating activities disallowed at nonsample stores;
removing the restricted activities data from the projection;
generating replacement activities data for the nonsample stores; and
reassigning the replacement activities data to non-restricted plans based at least in part on factors applied to nonrestricted activities at nonsample stores.

2. The method of claim 1, wherein the activities include scripts purchases.

3. The method of claim 1, wherein the estimated total activities remains constant.

4. The method of claim 1, wherein reassigning the replacement activities data is based at least in part on historical ratios of sampled, restricted activities to sampled, non-restricted activities.

5. A method for projecting sample store activities that are restricted in non-sample stores, comprising:
determining restricted outlet-plan combinations applicable in a market region;
generating exclusion lists of nonsample stores;
generating restricted plan allocation data;
generating restricted plan adjustments (RPA) factors data;
selecting, from a current week sample TRxs data file, a first group including scripts associated with a restricted plan and a second group including scripts not associated with a restricted plan;
appending RPA factors to one or more scripts in the first group; and
adjusting missing supplier records.

6. The method of claim 5, further comprising:
generating reverse roster data identifying which outlets a restricted plan is not allowed to fill prescriptions for.

7. The method of claim 6, further comprising:
generating the roster data by combining the current month next generation prescription services universe, current month plan rosters for restricted plans, and coverage area.

8. The method of claim 5, further comprising:
summing, at the outlet-product-plan level, non-missing supplier weights to create RPA factors

9. a method for projecting sample store activities that are restricted in non-sample stores, comprising:
determining restricted outlet-plan combinations;
exploding an exclusion/inclusion parameter files;
creating a restricted plan allocation file;
appending allocations to weight files;
creating factor files from the weight files;
transforming factors;
splitting sample file;
applying factors to rxs;
splitting missing supplier weights; and
appending missing supplier weights to sample rxs.

10. An article of manufacture comprising a computer readable medium having computer executable instructions embodied therein, the computer instructions for projecting sample store activities that are restricted in non-sample stores, the computer executable instructions causing a computer system to perform the steps comprising:
identifying restricted activities data within a projection, the restricted activities data indicating activities disallowed at nonsample stores;
removing the restricted activities data from the projection;
generating replacement activities data for the nonsample stores; and
reassigning the replacement activities data to non-restricted plans based at least in part on factors applied to nonrestricted activities at nonsample stores.

11. The article of manufacture of claim 10, wherein the activities include scripts purchases.

12. The article of manufacture of claim 10, wherein the estimated total activities remains constant.

13. The article of manufacture of claim 10, wherein reassigning the replacement activities data is based at least in part on historical ratios of sampled, restricted activities to sampled, non-restricted activities.
